(19) United States
(12) Patent Application Publication
(10) Pub. No.: US 2007/0092617 A1
(43) Pub. Date: Apr. 26, 2007

(54) APPARATUS FOR USE IN MAKING RUMINANT FEEDSTUFF

(76) Inventors: Arnaldo Burgos, Chandler, AZ (US); William Bailey, Phoenix, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/534,080

(22) Filed: Sep. 21, 2006

Related U.S. Application Data
(60) Provisional application No. 60/719,121, filed on Sep. 21, 2005.

(51) Int. Cl. A01J 25/00

(52) U.S. Cl. 426/519

(57) ABSTRACT

A system for use in making a ruminant feedstuff comprises a blender configured to receive a stoichiometric mixture of a fatty acid and a calcium oxide. A pump operably connected to the blender pumps the mixture from the blender. At least two mixing chambers are arranged in parallel, wherein at least one of the mixing chambers is configured to receive a flow of the mixture from the pump, and wherein each of the mixing chambers has a plurality of atomization nozzles formed on a surface thereof along at least a portion of the length of the mixing chamber. The atomization nozzles are configured to receive a measured amount of water proportional to the stoichiometric mixture therethrough. A mixer, which is removably mounted in the mixing chamber, is configured to generate turbulence in the flow of the mixture as it passes through the mixing chamber.

### CROSS-REFERENCE TO RELATED APPLICATIONS

The present application is based on and claims the benefit of U.S. Provisional Patent Application No. 60/719,121, filed on Sep. 21, 2005, the entire contents of which is hereby incorporated by reference and should be considered part of this specification.

### BACKGROUND OF THE INVENTION

1. Field of the Invention

The present invention relates to ruminant feedstuffs and, in particular, to the production of ruminant feedstuffs containing edible fatty acid salts.

2. Description of the Related Art

A number of methods have been proposed for protecting fats and proteins from the effects of rumen fermentation during the digestion process so that they are not digested until they reach the intestine of the ruminant. Such methods have for the most part depended upon protecting such fats and/or proteins in a coating which resists the fermentation processes of the rumen. Therefore, a proportion of the ruminant's dietary requirement can be provided in the form of nutrients that do not undergo alteration or degradation in the rumen, resulting in optimum milk and meat production.

One method involves providing a ruminant feedstuff comprising a water-insoluble salt made of one or more edible fatty acids. The water-insoluble salt is made by forming a mixture of calcium oxide or other edible water-insoluble basic oxide, one or more fatty acids, and water. The calcium (or other) oxide reacts exothermically with the acid and water to form the calcium salt. One such process and apparatus for making such ruminant feedstuff are disclosed in U.S. Pat. Nos. 4,909,138 and 4,853,233 issued to McAskie.

A disadvantage with known methods of preparing such ruminant feedstuff is that they may not provide adequate mixing of the fatty acids, calcium oxide and water, resulting in pockets of unreacted chemicals. Such unreacted chemicals make the mixture unstable. If such unreacted chemicals later come in contact with water, they will cause an exothermal reaction that releases a lot of heat.

Therefore, an improved device and method for preparing ruminant feedstuff containing water-insoluble salts is needed.

### SUMMARY OF THE INVENTION

In accordance with one aspect of the present invention, an apparatus for use in making a ruminant feedstuff is provided. The apparatus comprises a mixing chamber extending along an axis and having a length from an inlet at a proximal end to an outlet at a distal end. The mixing chamber also has at least one nozzle disposed along at least a portion of the length. The mixing chamber configured to receive through said inlet and said nozzles a measured amount of palm fatty acid distillate, a measured amount of calcium oxide, and a measured amount of water, which together form a mixture. A mixer is removably positioned in the mixing chamber, the mixer comprising a shaft extending generally along the axis. At least one mixing blade is rotatably mounted to the shaft, the mixing blade configured to rotate as the mixture flows through the mixing chamber to mix the mixture. At least one blocking element is disposed proximal of the mixing blade, the blocking element configured to generate a turbulent flow within the mixing chamber to further mix the mixture.

In accordance with another aspect of the invention, a system for use in making a ruminant feedstuff is provided. The system comprises a mixing vat configured to receive a generally stoichiometric mixture of fatty acid and calcium oxide. A pump is configured to pump the mixture from the mixing vat to a mixing chamber, the mixing chamber extending along a length and having a plurality of nozzles disposed along at least a portion of the length. The nozzles are configured to receive a measured amount of water therethrough in a desired proportion to said generally stoichiometric mixture. A mixer is removably positioned in the mixing chamber. The mixer comprises a shaft extending generally along the length of the mixing chamber. A plurality of mixing blades are rotatably mounted to the shaft and configured to rotate as the mixture and water flow through the mixing chamber to mix the mixture and water into a feedstuff. At least one blocking element is configured to generate a turbulent flow within the mixing chamber to further mix the mixture and water into feedstuff. At least one movable surface is configured to receive the feedstuff from the mixing chamber, the moveable surface configured to facilitate the drying and curing of the feedstuff.

In accordance with another aspect of the present invention, an apparatus for use in making ruminant feedstuff is provided. The apparatus comprises a mixing chamber having a proximal end, a distal end, and a plurality of nozzles, the mixing chamber configured to receive a fatty acid mixture through the proximal end and water through the nozzles. A mixer is removably mounted in the mixing chamber and has a shaft, at least one stator blade mounted to the shaft, at least one blocking element disposed proximal the stator blade, and at least one movable blade rotatably mounted to the shaft and configured to rotate as the fatty acid mixture flows through the mixing chamber.

In accordance with another aspect of the present invention, a system for use in making a ruminant feedstuff is provided. The system comprises a mixing vat configured to receive a generally stoichiometric mixture of a fatty acid and a calcium oxide. A pump is operably connected to the mixing vat and is configured to pump the mixture from the vat. At least two mixing chambers are arranged in parallel. At least one of the mixing chambers is configured to receive a flow of the mixture from the pump, each of the mixing chambers having a plurality of nozzles formed on a surface thereof along at least a portion of a length of the mixing chamber. The nozzles are configured to receive a measured amount of water therethrough having a desired proportion to the generally stoichiometric mixture. A mixer is removably mounted in the mixing chamber, the mixer configured to generate turbulence in the flow of the mixture as it passes through the mixing chamber.

In accordance with another aspect of the present invention, an apparatus for use in making ruminant feedstuff is provided. The apparatus comprises a mixing chamber having a proximal end, a distal end, and a plurality of nozzles. The mixing chamber is configured to receive a fatty acid mixture through the proximal end and water through the nozzles. A mixer is removably mounted in the mixing chamber and has a shaft, at least one stator blade mounted to the shaft, at least one blocking element disposed proximal the stator blade, and at least one movable blade rotatably mounted to the shaft and configured to rotate as the fatty acid mixture flows through the mixing chamber.

In accordance with another aspect of the invention, a system for use in making a ruminant feedstuff is provided. The system comprises a mixing vat configured to receive a generally stoichiometric mixture of a fatty acid and a calcium oxide. A pump is operably connected to the mixing vat and is configured to pump the mixture from the vat. At least two mixing chambers are arranged in parallel. At least one of the mixing chambers is configured to receive a flow of the mixture from the pump, each of the mixing chambers having a plurality of nozzles formed on a surface thereof along at least a portion of a length of the mixing chamber. The nozzles configured to receive a measured amount of water therethrough having a desired proportion to the generally stoichiometric mixture. A mixer is removably mounted in the mixing chamber, the mixer configured to generate turbulence in the flow of the mixture as it passes through the mixing chamber.

In accordance with still another aspect of the present invention, an apparatus for use in making ruminant feedstuff is provided. The apparatus comprises a mixing chamber having a proximal end, a distal end, and a plurality of nozzles. The mixing chamber is configured to receive a fatty acid mixture through the proximal end and water through the nozzles. A mixer is removably mounted in the mixing chamber and has means for mixing the fatty acid mixture and water.

In accordance with yet another aspect of the present invention, a method for making a ruminant feedstuff is provided. The method comprises mixing a generally stoichiometric amount of a fatty acid and a calcium oxide. The method also comprises continuously discharging a measured amount of water into a continuous flow of the stoichiometric mixture to form a feedstuff mixture, the measured amount of water being in a desired proportion to the generally stoichiometric mixture. The method further comprises generating turbulence to substantially mix the feedstuff mixture.

### BRIEF DESCRIPTION OF THE DRAWINGS

The following figures illustrate a preferred embodiment of the present invention. However, one of ordinary skill in the art will understand that the figures are for illustrative purposes only, and that the invention extends beyond the specifically illustrated embodiment. Accordingly, the invention is not intended to be limited to the specific disclosures of the preferred embodiment described below.

FIG. 1 is a schematic view of a system for preparing ruminant feedstuff according to a preferred embodiment of the invention.

FIG. 2 is a partial cross-section side view of a preferred embodiment of a mixing chamber for use in the system of FIG. 1.

FIG. 3 is an exploded view of the mixing chamber in FIG. 2.

### DETAILED DESCRIPTION OF THE PREFERRED EMBODIMENT

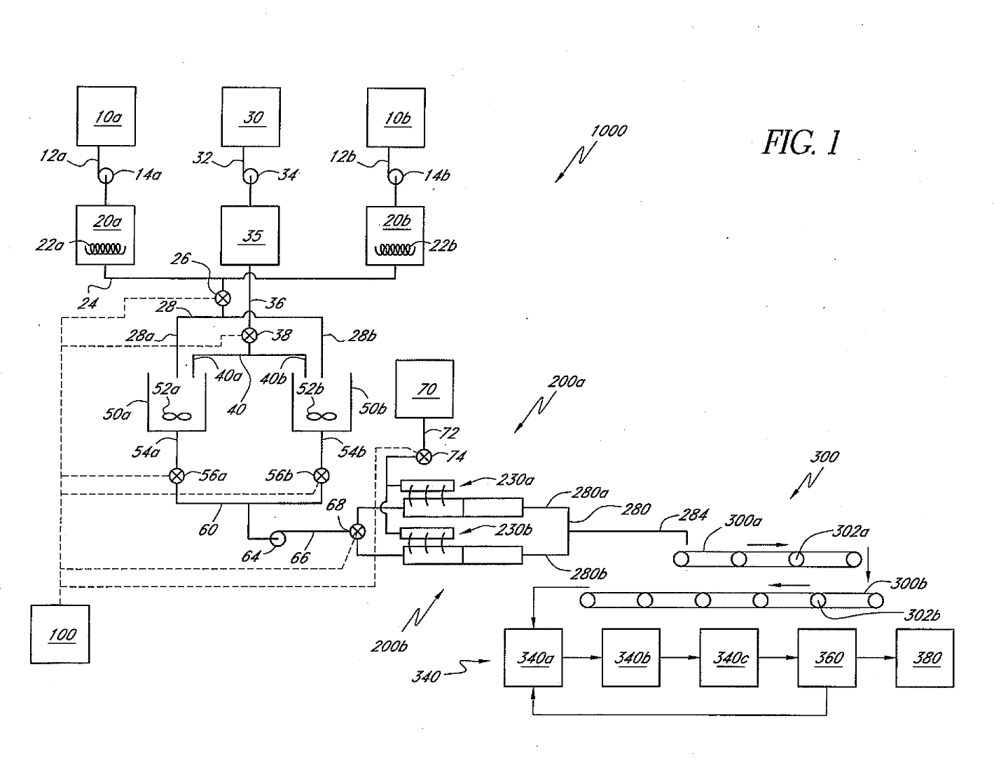

FIG. 1 illustrates one embodiment of a system 1000 for preparing ruminant feedstuff. In the illustrated embodiment, a fatty acid may be stored in bulk storage tanks 10a, 10b. Each of the bulk storage tanks 10a, 10b preferably supplies the fatty acid through conduits 12a, 12b to a corresponding work tank 20a, 20b. In the illustrated embodiment, pumps 14a, 14b pump the fatty acid to the work tanks 20a, 20b. Preferably, the fatty acid is a palm fatty acid distillate (PFAD), such as for example palm oil. However, one of ordinary skill in the art will recognize that other types of fatty acids and other materials can be used, such as for example, but without limitation, fish oil, corn oil, sunflower oil, or tallow.

The fatty acid is preferably pre-heated to a desired temperature via processes using conduction and/or convection heat transfer. For example, as shown in FIG. 1, the work tanks 20a, 20b have heating elements 22a, 22b disposed therein to heat the fatty acid. In another embodiment, a heat exchanger can be disposed outside the tanks 20a, 20b and coupled to the tanks 20a, 20b to heat the fatty acid. In still another embodiment, a combination of heating elements 22a, 22b and other heat exchangers can be used to heat the fatty acid. One of ordinary skill in the art will recognize that various heat exchanger designs can be used to heat the fatty acid, and that such heating can take place via conduction and/or convection. The heating elements 22a, 22b preferably maintain the fatty acid at a temperature in a range between about 100° F. and about 150° F. In one embodiment, the heating elements 22a, 22b maintain the fatty acid at a temperature of about 130° F. Temperature sensors (not shown) can be used to sense the temperature of the fatty acid in the tanks 20a, 20b. The temperature sensors communicate with a controller 100, which controls the operation of the heating elements 22a, 22b to maintain the fatty acid at the desired temperature. The controller 100 is discussed further below.

In a preferred embodiment, the fatty acid passes from the work tanks 20a, 20b into a manifold 24, as shown in FIG. 1. The manifold 24 connects to a supply control valve 26, which preferably regulates the flow of fatty acid through a manifold 28 having ends 28a, 28b. The supply control valve 26 is operated as further described below.

The system 1000, as illustrated in FIG. 1, also comprises a holding tank 30, which preferably contains calcium oxide. The holding tank 30 supplies calcium oxide to a classifier 35 or sorter, which sorts the calcium oxide to allow particles of a size in the range of between about 70 micron and about 90 micron, more preferably about 75 micron to pass into a conduit 36. However, in other embodiments other suitable particle sizes can be used. Preferably, substantially all of the particles, and more preferably 100% of the particles, pass into the conduit 36. The conduit 36 connects to a second supply control valve 38, which preferably regulates the flow of calcium oxide through a manifold 40 having ends 40a, 40b. The second supply control valve 38 is operated as described below.

As shown in FIG. 1, the fatty acid is supplied through the ends 28a, 28b of the manifold 28 into mixing vats or blenders 50a, 50b. Likewise, calcium oxide is supplied through the ends 40a, 40b of the manifold 40 into the mixing vats 50a, 50b. In a preferred embodiment, the supply valves 26, 38 include flow meters for measuring the amount of fatty acid and calcium oxide, respectively, being supplied to the mixing vats 50a, 50b. In another embodiment, flow meters can be disposed proximal the supply valves 26, 38. The operation of the supply valves 26, 38 is controlled, as described further below, to provide measured amounts of the fatty acid and calcium oxide to the mixing vats 50a, 50b in order to produce a generally stoichiometric mixture of fatty acid and calcium oxide. The mixing vats 50a, 50b preferably have mixing elements 52a, 52b disposed therein for mixing the fatty acid and calcium oxide into a slurry mixture. In the illustrated embodiment, the mixing elements 52a, 52b are blades. However, any suitable mixing element configured to adequately mix the fatty acid and calcium oxide can be used. In a preferred embodiment, the mixing elements 52a, 52b are operated over a period of time and at a speed that thoroughly mixes the fatty acid and calcium oxide without introducing a significant amount of air into the slurry mixture. For example, the mixing elements 52a, 52b can be operated at a speed and for a time period necessary to achieve a good distribution of the calcium oxide in the volume of fatty acid.

In the illustrated embodiment, the slurry exits the mixing vats 50a, 50b via conduits 54a, 54b and their associated flow control valves 56a, 56b, which are operated in a manner described below. In one embodiment, the flow control valves 56a, 56b connect to a manifold 60, which in turn connects to a pump 64. Preferably the pump 64 is a positive displacement pump. In one preferred embodiment, the pump 64 is a gear pump. However, the pump 64 can be any pump suitable to provide the desired flow of the slurry mixture.

As shown in FIG. 1, the pump 64 preferably pumps the slurry mixture through a conduit 66 and a valve 68, which controls the flow of the slurry mixture into a mixing chamber 200. Preferably, a flow meter (not shown) communicates with the valve 68 and measures the amount of slurry mixture passing therethrough. In the illustrated embodiment, two mixing chambers 200a, 200b are shown connected in parallel to the valve 68. In one preferred embodiment, the valve 68 is a three-way valve that allows the slurry to flow through one of the mixing chambers 200a, 200b at any one time. Accordingly, in the illustrated embodiment one mixing chamber 200a can be taken off-line (e.g., for maintenance or cleaning) while the other mixing chamber 200b remains in operation. For example, in one embodiment, the mixing chambers 200a, 200b can be taken off-line, in alternating fashion, about every twenty minutes for cleaning.

In the illustrated embodiment, a supply tank 70 supplies water through a conduit 72 and a flow control valve 74 to water manifolds 230a, 230b. Preferably, the tank 70 supplies water at a generally constant pressure. In one embodiment, the flow control valve 74 includes a flow meter and provides a measured amount of water therethrough. Preferably, the measured amount of water is supplied in a desired proportion to the amount of the slurry mixture entering the mixing chambers 200a, 200b. In one embodiment, the flow control valve 74 is an on/off valve. In another embodiment, the flow control valve 74 is a throttle valve. The manifolds 230a, 230b in turn discharge the water into the mixing chambers 200a, 200b. The addition of water to the slurry mixture creates a feedstuff mixture and results in an exothermic reaction, as further described below.

As illustrated in FIG. 1, the feedstuff mixture exits the mixing chambers 200a, 200b through conduits 280a, 280b of manifold 280 and via discharge conduit 284 onto a moving surface 300. In the illustrated embodiment, the moving surface 300 includes two conveyor belts 300a, 300b. However, one of ordinary skill in the art will readily recognize that one or any number of conveyor belts can be used. In one preferred embodiment, the conveyor belts 300a, 300b operate at a speed controlled by the controller 100, as described below.

As the feedstuff mixture exits the discharge conduit 284, the slurry mixture expands into a generally continuous layer and exothermically reacts. In the illustrated embodiment, as the feedstuff mixture passes from the first conveyor belt 300a to the second conveyor belt 300b, the layer preferably breaks up into smaller clumps of the feedstuff mixture. The feedstuff mixture additionally cures and cools as it travels on the conveyor belts 300a, 300b. In one embodiment, the conveyor belts 300a, 300b move over rollers 302a, 302b in an undulating manner that further facilitates the break-up of the feedstuff mixture into smaller clumps. Preferably, the conveyor belts 300a, 300b operate at a speed sufficient to allow the desired curing and cooling of the feedstuff mixture.

In a preferred embodiment, the feedstuff mixture passes from the conveyor belts 300a, 300b into at least one auger 340, which grinds and further cools the feedstuff mixture. In the illustrated embodiment, three augers 340a, 340b, 340c are shown. However, one of ordinary skill in the art will recognize that any number of augers can be used. The augers 340a, 340b, 340c preferably grind and mix the feedstuff mixture so that the exothermic reaction is substantially complete. In a preferred embodiment, the feedstuff mixture has a moisture level in the range of between about 2% and about 4%. In another embodiment, the feedstuff mixture has a moisture level of less than about 2%.

The feedstuff mixture is then passed through a sizing machine 360, which preferably sifts the mixture into particles generally of a particular size and smaller. Preferably, the feedstuff mixture has particle sizes in a range of between about 170 SGN and about 190 SGN. In another embodiment, the feedstuff mixture has a particle size of no greater than about 260 SGN. Particles of the feedstuff mixture that are outside this range are returned to the augers 340a, 340b, 340c for further grinding. If the particles are within the desired range, they are directed to a bagging bin 380. The feedstuff mixture can be packaged for example, but without limitation, in different sized bags and in bulk form stored in containers, or can be loaded directly onto a truck.

The system 1000 described above is preferably automated and controlled by one or more controllers. As shown in FIG. 1, one controller 100 is used to control the production line; however, two or more controllers that operate independent of one another or that communicate with one another can also be used. In one preferred embodiment, the controller 100 communicates with the supply control valves 26, 38, the flow control valves 56a, 56b, 68, 72, and their associated flow meters. In another embodiment, the controller 100 also communicates with the temperature sensors in the tanks 20a, 20b and the heating elements 22a, 22b. In still another embodiment, the controller 100 also communicates with the conveyor belts 300a, 300b, and the pumps 14a, 14b, 34, 64. Though only some sensors are described above (e.g., flow meters, temperature sensors), one of ordinary skill in the art will recognize that various sensors can be used, which can communicate with the controller 100 and the various equipment components of the system 1000. In FIG. 1, the dashed lines represent communication lines between the different components and the controller 100. In one embodiment, the controller 100 communicates with the sensors and other components (e.g., valves, pumps) using signals sent via hard wire, infrared devices, RF devices, or the like.

The controller 100 preferably controls the operation of the pumps 14a, 14b, 34 to supply fatty acid and calcium oxide, respectively, from the storage/holding tanks 10a, 10b, 30 to the work tanks 20a, 20b and classifier 35, respectively.

The controller 100 also preferably controls the supply control valves 26, 38 to supply a generally stoichiometric amount of fatty acid and calcium oxide to the mixing vats 50a, 50b. For example, the controller 100 can receive signals from the flow meters of the supply control valves 26, 38 with the amounts of fatty acid and calcium oxide passing therethrough, respectively, and control the opening of the valves 26, 38 to adjust said amounts. In another embodiment, the controller 100 also controls the speed of the mixing elements 52a, 52b in the mixing vats 50a, 50b to achieve a desired consistency in the slurry mixture.

The controller 100 also preferably controls the operation of the flow control valves 56a, 56b. In one embodiment, the controller 100 controls the flow control valves 56a, 56b to allow flow of the slurry mixture from one mixing vat 50a, while the fatty acid and calcium oxide is mixed in the other mixing vat 50b.

In one embodiment, the controller 100 controls the operation of the pump 64 to pump the slurry mixture from the mixing vats 50a, 50b to the mixing chamber 200a, 200b. The controller 100 also preferably controls the supply valve 74 to supply an amount of water proportional to the slurry mixture passing through the mixing chamber 200a, 200b. In one embodiment, the controller 100 also controls the valve 68 to direct the flow of slurry mixture into one mixing chamber 200a, while allowing the other mixing chamber 200b to be taken off-line, as discussed above. In another embodiment, the valve 68 can be manually operated. In another embodiment, the controller 100 controls the speed of the conveyor belts 300a, 300b, as discussed above.

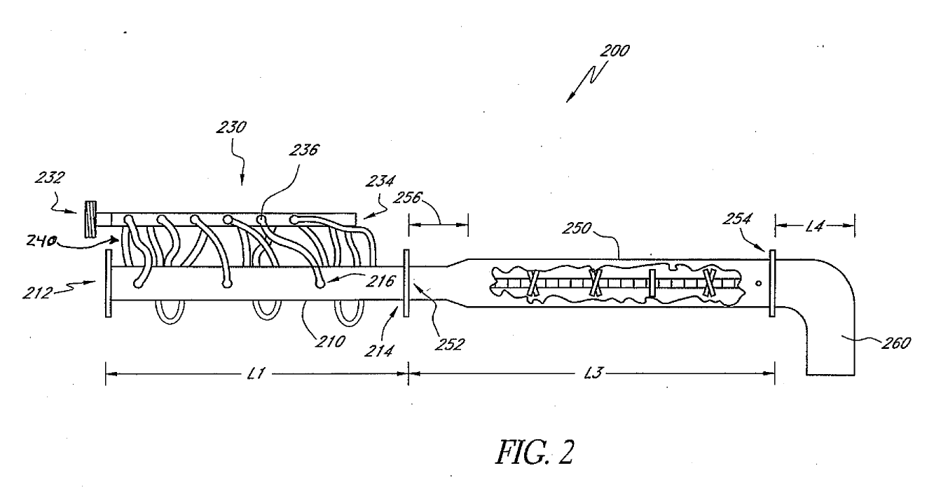

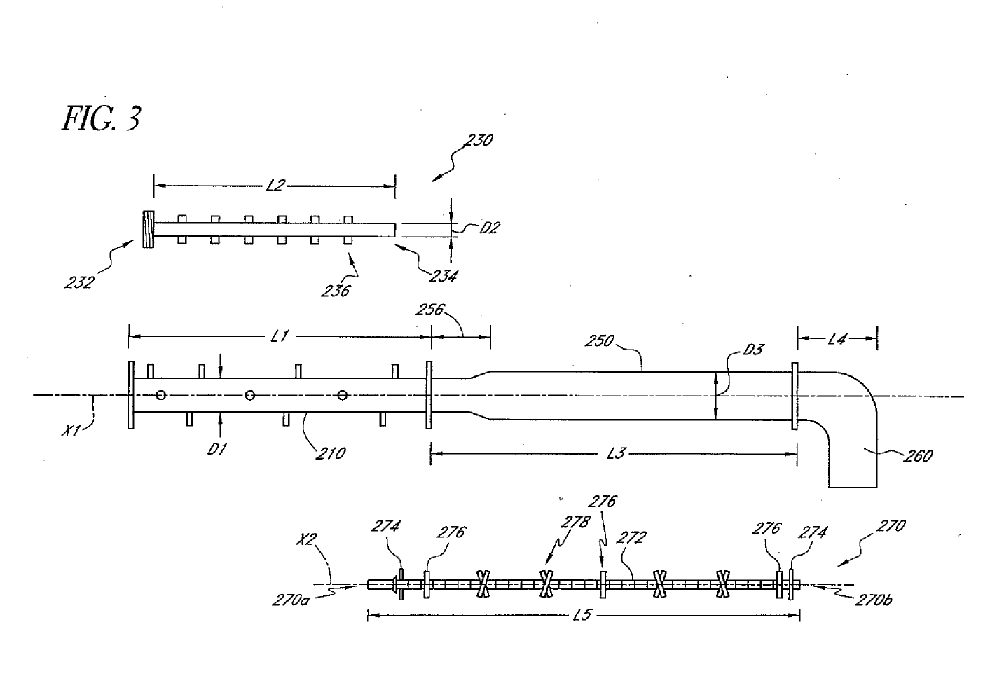

FIGS. 2-3 illustrate one embodiment of the mixing chamber 200 for use in preparing ruminant feedstuff. For this purpose, the mixing chamber 200 can be used in combination with the system 1000 illustrated in FIG. 1. However, the mixing chamber 200 can be used with any other system used to prepare ruminant feedstuff or similar product through continuous-flow production.

In the illustrated embodiment, the mixing chamber 200 includes an injection portion 210 extending from a proximal end 212 to a distal end 214 along a first length L1 and having a first diameter D1. Preferably, the injection portion 210 has at least one nozzle 216 disposed along the first length L1. In one embodiment, the nozzles 216 are atomization nozzles. Preferably, each nozzle 216 has a threaded portion for threadingly engaging a taped hole in the injection portion 210. In another embodiment, the nozzle 216 is welded to the tapped hole of the injection portion 210. In one embodiment, the flow of water into the injection portion 210 is controlled through each nozzle 216. For example, the nozzles 216 can have an adjustable valve structure (e.g., a solenoid valve) that regulates the amount of water that passes through the nozzle into the injection portion 210.

As illustrated in FIGS. 2-3, the injection portion 210 has multiple nozzles 216 distributed along the circumference and length of the injection portion 210. In a preferred embodiment, the nozzles 216 are distributed in a spiral configuration about the circumference of the injection portion 210. The nozzles 216 are staggered along the first length L1, with each of the nozzles 216 arranged at generally about 90 degrees from the adjacent nozzles 216. In the illustrated embodiment, the nozzles 216 are generally equidistant from one other along the first length L1. In another embodiment, the nozzles 216 can be arranged in a non-equidistant manner relative to each other. The orientation of the nozzles 216 is further discussed below.

An injection manifold 230 is provided along with the mixing chamber 200. The injection manifold 230 preferably extends from a proximal end 232 to a distal end 234 along a second length L2 and a second diameter D2, and includes at least one outlet port 236 formed on a surface thereof. The length L2 is preferably the same as the length L1 of the injection portion 210 to minimize the delivery time of water to the injection portion 210. In the illustrated embodiment, the injection manifold 230 has multiple outlet ports 236 formed on the surface of the manifold on at least two sides of the circumference of the manifold. As illustrated in FIG. 2, the injection manifold 230 is preferably operably connected to the injection portion 210 of the mixing chamber 200 via at least one connecting runners 240. In the illustrated embodiment, multiple connecting runners 240 extend from the outlet ports 236 on the injection manifold 230 to the nozzles 216 on the injection portion 210 of the mixing chamber 200. In one embodiment, the connecting runners 240 can be hoses made of cross-linked polyurethane rubber or a similar flexible material. In another embodiment, the connection runners 240 can be metal or metal braided tubing. Preferably, the connection runners 240 are configured to withstand operating pressures between about 90 lbs and about 150 lbs.

With continued reference to FIGS. 2-3, the injection portion 210 of the mixing chamber 200 preferably connects to a mixing portion 250 that extends from a proximal end 252 to a distal end 254 along a third length L3 and has a third diameter D3. Preferably, the first and third lengths L1, L3 extend along a common axis X1. In the illustrated embodiment, the mixing chamber 200 has a transition section 256, wherein the diameter of the mixing chamber 200 transitions from the first diameter D1 of the injection portion 210 to the third diameter D3 of the mixing portion 250. In another embodiment, the transition section 256 is part of the injection portion 210. The injection portion 210 and the mixing portion 230 can be integral. In the illustrated embodiment, however, the injection portion 210 and the mixing portion 230 are separate components fastened together with fasteners such as bolts, screws, welds, or brackets. One of the components is preferably detachable to remove a mixer 270 (discussed further below) for cleaning or other maintenance purposes.

As shown on FIG. 2, an outlet 260, having a length L4, connects to the distal end 254 of the mixing portion 250 of the mixing chamber 200. In the illustrated embodiment, the outlet 260 has a bend so as to direct the slurry material passing through the mixing chamber 200 in a direction generally perpendicular to the direction of the axis X1 of the mixing chamber 200. In another embodiment, the outlet 260 can be oriented so as to be generally parallel to the axis X1 of the mixing chamber 200. The outlet 260 is removably fastened to the distal end 254 of the mixing portion 250.

FIG. 3 illustrates one embodiment of the mixer 270 that is removably mounted in the mixing portion 250 of the mixing chamber 200. The mixer 270 extends from a proximal end 270a to a distal end 270b along a length L5. Preferably, the mixer 270 is coaxial with the mixing portion 250. That is, the length L5 preferably extends along an axis X2, wherein the axis X2 is at least generally parallel to the axis X1 of the mixing portion 250. Preferably, the length L5 of the mixer 270 is at least as long as the length L3 of the mixing portion 250. In another embodiment, the mixer 270 extends into the transition section 256.

The mixer 270 preferably comprises a shaft 272 that holds thereon at least two stator blades 274 near the proximal and distal ends 270a, 270b of the mixer 270. A stator blade 274 can also be located generally at the center of the length L5. Each of the stator blades 274 preferably has a diameter substantially equal to the diameter D3 of the mixing portion 250. Also, each of the stator blades 274 has one or more openings therein. Additionally, at least two blocking elements 276 are disposed near each of the stator blades 274, each of the blocking elements 276 having one or more aperture therein and having a diameter substantially equal to the diameter D3 of the mixing portion 250. In another embodiment, the mixer 270 can have one stator blade 274 and one blocking element 276. In still another embodiment, the mixer 270 can have multiple stator blades 274 and multiple blocking elements 276. In the illustrated embodiment, a blocking element 276 is also located generally at the center of the length L1.

As shown in FIG. 3, one or more movable blades 278 are mounted on the shaft 272; the blades 278 have a diameter smaller than the diameter D3 of the mixing portion 250 and are configured to rotate about the shaft 272. In one embodiment, the movable blades 272 are disposed equidistantly from one other. In another embodiment, the movable blades 272 can be disposed at non-equidistant locations. The movable blades 272 can be disposed in any suitable arrangement to provide the desired mixing of the slurry mixture.

With reference to FIG. 2, the length L1 and diameter D1 of the injection portion 210, as well as the number and diameter of the nozzles 216, are preferably chosen so as to inject the measured amount of water in the desired proportion to the slurry mixture flowing through the injection portion 210 and to achieve the desired distribution of water relative to the slurry mixture in the injection portion. For example, for a given slurry flow rate, or range of flow rates, a given diameter D1, a given water pressure, and a given nozzle 216 diameter, the number of nozzles can be chosen to provide the water flow rate in the desired proportion relative to the slurry flow rate. Additionally, the length L1 is chosen to achieve the desired distribution of water in the slurry mixture. In one embodiment, for a slurry flow rate of between about 30 GPM and 50 GPM, more preferably about 40 GPM, the length L1 of the injection portion 210 is between about 25 inches and about 30 inches, and more preferably about 27 inches. Additionally, the diameter D1 of the injection portion is preferably between about 1.5 inches and about 3 inches, and more preferably about 2 inches. Further, the nozzles 216 have a diameter suitable to provide a water flow rate of between about 7 GPM and 12 GPM, more preferably 9.2 GPM; for example, the nozzles 216 can have a diameter of between about ¼ inch and about ½ inch, and more preferably about ⅜ inch. Moreover, the injection portion 210 of the mixing chamber 200 preferably has between about 5 and about 15 nozzles 216 along the first length L1. In the illustrated embodiment, twelve nozzles 216 are disposed on the injection portion. As discussed above, the nozzles 216 are preferably disposed along the circumference of the injection portion 210 so as to provide a generally uniform distribution of water injected into the injection portion 210 (e.g., provide a desired ratio of water to slurry mixture as said mixture moves through the injection portion 210). Additionally, the ninety-degree offset of the nozzles 216 promotes mixing between the injected water and the slurry mixture.

The length L2 of the injection manifold 230 is preferably between about 20 inches and about 30 inches, and more preferably about 26½ inches. Additionally, the diameter D2 of the injection manifold is preferably between about ½ inch and about 1.5 inches, for example about 1 inch. Further, the diameter of the outlet ports 236 on the injection manifold 230 is preferably between about ½ inch and about 1 inch, for example about ¾ inch. In a preferred embodiment, the outlet ports 236 on the injection manifold 230 are disposed equidistantly from one other along the length L2 of the injection manifold 230. In another embodiment, the outlet ports 236 on the injection manifold 230 can be disposed at non-equidistant locations. Moreover, the number of outlet ports 236 is preferably equal to the number of nozzles 216. The length L2 and diameter D2 of the injection manifold 230, as well as the diameter and distribution of outlet ports, is preferably chosen to provide the necessary amount of water to the injection portion 210 in the desired proportion to the expected range of flow rates for the slurry mixture and at a desired pressure.

With further reference to FIG. 2, the length L3 of the mixing portion 250 of the mixing chamber 200 is preferably longer than the first length L1 of the injection portion 210. Preferably, the length L3 is chosen to achieve the desired mixing of the slurry mixture and water, based on the flow rate of slurry mixture and the rate of absorption of water by the slurry mixture. Additionally, for the given flow rate of slurry mixture, the length L3 is preferably sufficient to achieve the desired mixing without having the slurry mixture and water substantially react until they exit the mixing portion 250. In one embodiment, the length L3 is between about 1.25 times and about 2 times the first length L1, and more preferably about 1.5 times the first length L1. In one embodiment, the length L3 is between about 30 inches and about 50 inches, and more preferably about 40 inches. Additionally, the diameter D3 of the mixing portion 250 is preferably between about 2¼ inches and about 3 inches, and more preferably about 2½ inches. Further, the transition section 256 between the first diameter D1 of the injection portion 210 and the third diameter D3 of the mixing portion 250 is preferably between about 1 inch and about 5 inches in length, and more preferably about 3 inches. In one embodiment, the first diameter D1 and the third diameter D3 are equal. Also, the outlet 260 connected to the distal end 254 of the mixing portion 250 preferably has a length of between about 3 inches and about 6 inches, and more preferably about 5 inches. Additionally, the outlet preferably has a diameter of between about 2¼ inches and about 3 inches, and more preferably about 2½ inches. In a preferred embodiment, the outlet has the same diameter as the third diameter D3 of the mixing portion 250.

The length L5 of the mixer 270 is preferably between about 30 inches and about 50 inches, and more preferably about 40 inches. In a preferred embodiment, the blocking elements 276 and movable blades 278 are disposed equidistantly along the length L4 of the mixer 270. In another embodiment, the movable blades 278 are disposed at different distances from each other, as desired by the user. Further, in one embodiment, the movable blades 278 are adjustable so as to be disposed at a desired location along the length L4 of the shaft 272.

In a preferred embodiment, the mixing chamber 200 and the mixer 270 are made of metal. In one embodiment, the mixing chamber 200 and the mixer 270 can be made of stainless steel or a carbon steel material. In another embodiment, the mixer 270 and the mixing chamber 200 can be made of metal alloys. However, one of ordinary skill in the art will recognize that the mixing chamber 200 and the mixer 270, according to the embodiments disclosed herein, can be made of any suitable materials used in the production of animal feedstuff.

As the slurry mixture is pumped through the injection portion 210 of the mixing chamber 200, the measured amount of water is injected through the injection manifold 230, through the outlet ports 236, and into the injection portion 210 via the nozzles 216. In a preferred embodiment, each of the nozzles 216 is operated at generally the same pressure. The slurry material is thus substantially uniformly exposed to pressurized water as it moves through the injection portion 210 and into the mixing portion 250 of the mixing chamber 200. Preferably, the measured amount of water is in a proportion relative to the amount of slurry material flowing through the injection portion 210 so as to cause a full reaction of the slurry material. The slurry material then passes into the mixing portion 250, and through openings in the stator blades 274 and the apertures in the blocking elements 276. Advantageously, at least one of the stator blades 274 and blocking elements 276 of the mixer 270 generate back pressure at the proximal end of the mixing portion 250. The back pressure causes the flow of the slurry mixture to become turbulent, thus enhancing the mixing of the slurry mixture and water in the mixing portion 250. Additionally, the non-laminar flow through the mixing portion 250 causes the blades 278 to spin, which further enhances the mixing of the slurry mixture and water in the mixing portion 250. In another embodiment, the mixing portion 250 can have varying dimensions (e.g., a smaller diameter portion following a larger diameter portion) to generate said back pressure. In still other embodiments, vanes or baffles can be disposed inside the mixing portion 250 to generate turbulence in the flow of the feedstuff mixture as it passes through the mixing chamber. Accordingly, the flow of slurry mixture and water is pressurized in the mixing portion 250. One or ordinary skill in the art will recognize that various other mechanisms can be used to create back pressure and turbulent flow.

In the embodiments discussed above, the injection manifold 230 is used to inject water into the injection portion 210 whereas the fatty acid and calcium oxide slurry mixture enters the injection portion 210 through the proximal end 212. However, one of ordinary skill will recognize that in another embodiment, the water and calcium oxide can be mixed in the mixing vats 50a, 50b and injected into the mixing chamber 200 through the proximal end 212 of the injection portion 210, while the fatty acid can be injected through the injection manifold 230 and through the nozzles 216 into the injection portion 210. In still another embodiment, the water and fatty acids can be combined in the mixing vats 50a, 50b and then provided to the injection portion 210 through its proximal end 212, while the calcium oxide can injected through the injection manifold 230 and through the nozzles 216 into the injection portion 210 of the mixing chamber 200. In still another embodiment calcium oxide can be combined with water and injected through the injection manifold 230 and the nozzles 216 into the injection portion 210, while the fatty acid is delivered through the proximal end 212 of the injection portion 210.

Though the mixture discussed above in connection with the embodiments for producing ruminant feedstuff combines a fatty acid, calcium oxide, and water, one of ordinary skill in the art will recognize that other materials can also be used in addition to the ones disclosed herein. In one embodiment, flavored materials can be used and added to the blender along with the calcium oxide and fatty acid. In another embodiment, nutrients can be added along with the calcium oxide and fatty acids in the blender.

The devices and systems described above provide a number of ways to carry out the invention. Of course, the foregoing description is that of certain features, aspects and advantages of the present invention to which various changes and modifications can be made without departing from the spirit and scope of the present invention. Moreover, the devices and systems may not feature all objects and advantages discussed above to use certain features, aspects and advantages of the present invention. Thus, for example, those skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still following the scope of the invention. Accordingly, it should be understood that various features and aspects of the disclosed embodiments can be combined with or substituted for one another in order to form varying modes of the discussed devices and systems.

What is claimed is:

1. An apparatus for use making a ruminant feedstuff, comprising:
a mixing chamber extending along an axis and having a length from an inlet at a proximal end to an outlet at a distal end, the mixing chamber also having at least one nozzle disposed along at least a portion of the length, the mixing chamber configured to receive through said inlet and said nozzles a measured amount of palm fatty acid disellate, a measured amount of calcium oxide, and a measured amount of water, which together form a mixture; and
a mixer removably positioned in the mixing chamber, the mixer comprising
a shaft extending generally along the axis,
at least one mixing blade rotatably mounted to the shaft, the mixing blade configured to rotate as the mixture flows through the mixing chamber to mix the mixture, and
at least one blocking element disposed proximal of the mixing blade, the blocking element configured to generate a turbulent flow within the mixing chamber to further mix the mixture.

2. The apparatus of claim 1, further comprising a pair of stator blades mounted to the shaft and positioned at the proximal and distal ends.

3. The apparatus of claim 1, wherein the measured amount of water is introduced into the mixing chamber via the at least one nozzle.

4. The apparatus of claim 1, wherein the measured amount of calcium oxide is introduced into the mixing chamber via the at least one nozzle.

5. The apparatus of claim 1, wherein the measured amount of palm fatty acid disellate is introduced into the mixing chamber via the at least one nozzle.

6. A system for use in making ruminant feedstuff, comprising:
a mixing vat configured to receive a generally stoichiometric mixture of fatty acid and calcium oxide;
a pump configured to pump the mixture from the mixing vat to a mixing chamber, the mixing chamber extending along a length and having a plurality of nozzles disposed along at least a portion of the length, the nozzles configured to receive a measured amount of water therethrough in a desired proportion to said generally stoichiometric mixture;
a mixer removably positioned in the mixing chamber, the mixer comprising
a shaft extending generally along the length of the mixing chamber,
a plurality of mixing blades rotatably mounted to the shaft and configured to rotate as the mixture and water flow through the mixing chamber to mix the mixture and water into a feedstuff,
and at least one blocking element configured to generate a turbulent flow within the mixing chamber to further mix the mixture and water into feedstuff; and
at least one movable surface configured to receive the feedstuff from the mixing chamber, the moveable surface configured to facilitate the drying and curing of the feedstuff.

7. The system of claim 6, further comprising a sizing machine configured to size the feedstuff into particles generally of a particle size, flow control valves configured to regulate the amount of fatty acid, calcium oxide and water received, at least one sensor configured to sense an operating parameter, and a controller configured to communicate with the at least one sensor and flow control valves.

8. An apparatus for use in making ruminant feedstuff, comprising:
a mixing chamber having a proximal end, a distal end, and a plurality of nozzles, the mixing chamber configured to receive a fatty acid mixture through the proximal end and water through the nozzles; and
a mixer removably mounted in the mixing chamber having
a shaft,
at least one stator blade mounted to the shaft,
at least one blocking element disposed proximal the stator blade,
and at least one movable blade rotatably mounted to the shaft and configured to rotate as the fatty acid mixture flows through the mixing chamber.

9. A system for use in making ruminant feedstuff, comprising:
a mixing vat configured to receive a generally stoichiometric mixture of a fatty acid and a calcium oxide;
a pump operably connected to the mixing vat and configured to pump the mixture from the vat;
at least two mixing chambers arranged in parallel, at least one of the mixing chambers configured to receive a flow of the mixture from the pump, each of the mixing chambers having a plurality of nozzles formed on a surface thereof along at least a portion of a length of the mixing chamber, the nozzles configured to receive a measured amount of water therethrough having a desired proportion to the generally stoichiometric mixture; and
a mixer removably mounted in the mixing chamber, the mixer configured to generate turbulence in the flow of the mixture as it passes through the mixing chamber.

10. The system of claim 9, wherein at least one of the mixing chambers is removable from the system, while the mixture continues to flow through the system.

11. The system of claim 10, wherein the mixing chamber is removed from the system by actuating a one-way valve.

12. The system of claim 9, wherein the mixer is further configured to generate back pressure in the mixing chamber as the flow of the mixture passes through the mixing chamber.

13. The system of claim 9, further comprising a second mixing vat configured to receive a generally stoichiometric mixture of fatty acid and calcium oxide, pump operably connected to the second mixing vat.

14. An apparatus for use in making ruminant feedstuff, comprising:
a mixing chamber having a proximal end, a distal end, and a plurality of nozzles, the mixing chamber configured to receive a fatty acid mixture through the proximal end and water through the nozzles; and
a mixer removably mounted in the mixing chamber having means for mixing the fatty acid mixture and water.

15. The apparatus of claim 14, further comprising means for generating back pressure and turbulence in the mixing chamber.

16. A method for making a ruminant feedstuff, comprising:
mixing a generally stoichiometric amount of a fatty acid and a calcium oxide;
continuously discharging a measured amount of water into a continuous flow of the stoichiometric mixture to form a feedstuff mixture, the measured amount of water being in a desired proportion to the generally stoichiometric mixture; and
generating turbulence to substantially mix the feedstuff mixture.

17. The method of claim 16, further comprising substantially completely drying and cooling the feedstuff mixture.

18. The method of claim 16, further comprising sifting the feedstuff mixture into particles of a desired size.
